(19) United States
(12) Patent Application Publication
(10) Pub. No.: US 2023/0411603 A1
(43) Pub. Date: Dec. 21, 2023

(54) CATHODE ACTIVE MATERIAL COATED WITH OXIDE-BASED SOLID ELECTROLYTE AND SULFIDE-BASED SOLID ELECTROLYTE, AND ALL-SOLID-STATE BATTERY INCLUDING SAME

(71) Applicant: TDL CO., LTD., Gwangju (KR)

(72) Inventors: Yu Shin KIM, Gwangju (KR); Yong Suk KIM, Gwangju (KR); Da Hye KIM, Gwangju (KR)

(21) Appl. No.: 18/240,492

(22) Filed: Aug. 31, 2023

Related U.S. Application Data
(63) Continuation of application No. PCT/KR2022/011843, filed on Aug. 9, 2022.

(30) Foreign Application Priority Data
Aug. 9, 2021 (KR) 10-2021-0104882

(51) Int. Cl. H01M 4/36; H01M 4/505; H01M 4/525; H01M 4/62; H01M 10/0585; H01M 10/0562; H01M 4/131; H01M 10/42

(52) U.S. Cl. CPC H01M 4/366; H01M 4/505; H01M 4/525; H01M 4/62; H01M 10/0585; H01M 10/0562; H01M 4/131; H01M 10/4235; H01M 2004/028

(57) ABSTRACT

The present invention relates to an all-solid-state battery that can reduce the interfacial resistance between the electrolyte and electrode and can minimize the precipitation of lithium metal on the electrode and, more specifically, to an all-solid-state battery comprising: a cathode (100) including a cathode active material having a Li(NiₓCo_{y}Mn_{z})O₂ (wherein 0<x<1, 0<y<1, 0<z<1, and x+y+z=1) layer; an anode (300); and a hybrid solid electrolyte (200) located between the cathode (100) and the anode (300), wherein the hybrid solid electrolyte (200) includes at least two solid electrolyte layers having different densities.

### REFERENCE TO RELATED APPLICATIONS

This is a continuation of International Patent Application PCT/KR2022/011843 filed on Aug. 9, 2022, which designates the United States and claims priority of Korean Patent Application No. 10-2021-0104882 filed on Aug. 9, 2021, the entire contents of which are incorporated herein by reference.

### FIELD OF THE INVENTION

The present invention relates to a positive electrode active material coated with an oxide-based solid electrolyte and a sulfide-based solid electrolyte and an all-solid-state battery including the same. Particularly, the present invention relates to an all-solid-state battery including a positive electrode active material including a Li(NiₓCo_{y}Mn_{z})O2 (0<x<1, 0<y<1, 0<z<1, and x+y+z=1) layer, the positive electrode active material being coated with an oxide-based solid electrolyte and a sulfide-based solid electrolyte, and a hybrid solid electrolyte including solid electrolytes having different densities and a method of manufacturing the same. More particularly, the present invention relates to a positive electrode active material including a Li(NiₓCo_{y}Mn_{z})O₂ (0<x<1, 0<y<1, 0<z<1, and x+y+z=1) layer and LiCoO₂ formed on a lower surface of the Li(NiₓCo_{y}Mn_{z})O₂ layer without an additional material, the positive electrode active material being coated with an oxide-based solid electrolyte and a sulfide-based solid electrolyte, whereby it is possible to reduce the interfacial resistance at the interface between an electrode and the solid electrolyte and at the same time to prevent or reduce precipitation of lithium metal on the electrode, an all-solid-state battery including the same, and a method of manufacturing the all-solid-state battery.

### BACKGROUND OF THE INVENTION

A lithium ion secondary battery, which is a kind of secondary battery, has advantages of high energy density, low self-discharge rate, and long lifespan, compared to a nickel-manganese battery or nickel-cadmium battery, but has low stability against overheating and low output as disadvantages.

In order to overcome the above problems of the lithium ion secondary battery, an all-solid-state battery has been proposed as an alternative. The all-solid-state battery includes a solid electrolyte layer including a solid electrolyte and a positive electrode and a negative electrode formed on opposite surfaces of the solid electrolyte layer, respectively, each of the positive electrode and the negative electrode including a solid electrolyte, wherein each of the positive electrode and the negative electrode is made of a mixture of an electrode active material, a solid electrolyte, and a conductive agent.

The solid electrolyte may be mainly classified as an inorganic solid electrolyte and a polymer-based solid electrolyte based on the material that is used, wherein the inorganic solid electrolyte may be classified as an oxide-based solid electrolyte or a sulfide-based solid electrolyte. When the sulfide-based solid electrolyte is used, it is possible to achieve excellent output characteristics; however, there is a problem in that hydrogen sulfide (H₂S), which is a toxic gas, is generated. Recently, as safety of secondary batteries has become an issue, the oxide-based solid electrolyte has attracted attention due to excellent stability thereof although the oxide-based solid electrolyte exhibits lower ionic conductivity than the sulfide-based solid electrolyte.

In the solid electrolyte, ions move through a solid lattice. As a result, the solid electrolyte has a lower ionic conductivity than a liquid electrolyte, in which ions move freely through a fluid, the interfacial resistance between the solid electrolyte and the electrode is great, and the solid electrolyte has a lower capacity and efficiency than the lithium ion secondary battery.

In addition, the capacity of the all-solid-state battery may be increased using a method of increasing the thickness of a positive electrode layer and decreasing the thickness of the solid electrolyte layer; however, there are problems in that the amount of lithium metal precipitated from the negative electrode increases and short circuit easily occurs.

In this regard, Patent Document 1 discloses an all-solid-state battery including a positive electrode, a first solid electrolyte layer, a second solid electrolyte layer, and a negative electrode. At least two solid electrolyte layers are laminated between the first and second electrodes, and a part or the entirety of an outer edge of the second solid electrolyte layer is located outside an outer edge of the first solid electrolyte layer. That is, Patent Document 1 proposes a multilayered solid electrolyte layer configured to inhibit a possibility of occurrence of short circuit even when a metal such as lithium is precipitated at the negative electrode layer.

Patent Document 2 discloses a hybrid solid electrolyte sheet for all-solid-state lithium secondary batteries including a first solid electrolyte layer and a second solid electrolyte layer. The first solid electrolyte layer, which faces a negative electrode, includes a conductive polymer, and the second solid electrolyte layer, which faces a positive electrode, whereby the hybrid solid electrolyte sheet is capable of improving reversibility of lithium ions.

Each of Patent Document 1 and Patent Document 2 relates to a positive electrode active material and an all-solid-state battery including the same, wherein a double-structured solid electrolyte layer having different particle size and structure of a solid electrolyte from an electrode is formed, whereby the interfacial resistance at the interface of the solid electrolyte is reduced such that lithium ions move smoothly during a charging and discharging process, and the density of the solid electrolyte is improved such that lithium ions do not adhere to the electrode, whereby reversibility of lithium ions is improved, and therefore charging and discharging characteristics are maintained. However, none of the patent documents discloses a positive electrode including a positive electrode active material including a Li(NiₓCo_{y}Mn_{z})O₂ (0<x<1, 0<y<1, 0<z<1, and x+y+z=1) layer, the positive electrode active material being coated with an oxide-based solid electrolyte and a sulfide-based solid electrolyte, and the solid electrolyte.

### PRIOR ART DOCUMENTS

### Patent Documents

Korean Patent Application Publication No. 10-2021-0027023 (“Patent Document 1”)

Korean Registered Patent Publication No. 10-2212795 (“Patent Document 2”)

### SUMMARY OF THE INVENTION

The present invention, which has been made in view of the above problems, relates to a positive electrode active material capable of improving movement reversibility of lithium ions while reducing the interfacial resistance at the interface between an electrode and a solid electrolyte and an all-solid-state battery including the same. Particularly, it is an object of the present invention to provide a positive electrode including a positive electrode active material including a Li(NiₓCo_{y}Mn_{z})O₂ (0<x<1, 0<y<1, 0<z<1, and x+y+z=1) layer, the positive electrode active material being coated with an oxide-based solid electrolyte and a sulfide-based solid electrolyte, a hybrid solid electrolyte, and an all-solid-state battery including the same.

A positive electrode active material according to the present invention to accomplish the above object includes a Li(NiₓCo_{y}Mn_{z})O₂ (0<x<1, 0<y<1, 0<z<1, and x+y+z=1) layer and LiCoO2 formed on a lower surface of the Li(NiₓCo_{y}Mn_{z})O₂ layer, wherein the positive electrode active material is coated with an oxide-based solid electrolyte and a sulfide-based solid electrolyte.

In addition, the positive electrode active material may include Li₁+ₓNi₂-_{w}X_{w} (0<x<1 and 0<w<0.2) formed on an upper surface of the Li(NiₓCo_{y}Mn_{z})O₂ layer, wherein the positive electrode active material may be coated with the sulfide-based solid electrolyte after the positive electrode active material is coated with the oxide-based solid electrolyte.

In addition, the positive electrode active material may be coated with the oxide-based solid electrolyte and the sulfide-based solid electrolyte in the state in which each of the oxide-based solid electrolyte and the sulfide-based solid electrolyte has a concentration gradient.

An all-solid-state battery according to the present invention to accomplish the above object includes a positive electrode (100) including a positive electrode active material coated with an oxide-based solid electrolyte and a sulfide-based solid electrolyte, a negative electrode (300), and a hybrid solid electrolyte (200) located between the positive electrode (100) and the negative electrode (300), wherein the hybrid solid electrolyte (200) includes at least two solid electrolyte layers having different densities.

In addition, the hybrid solid electrolyte (200) may include a first solid electrolyte layer (210) including a low-density solid electrolyte and a second solid electrolyte layer (220) including a high-density solid electrolyte.

In addition, the second solid electrolyte layer (220) may further include a lithium salt.

In addition, the first solid electrolyte layer (210) may be located so as to face the positive electrode (100), and the second solid electrolyte layer (220) may be located so as to face the negative electrode (300).

In addition, the first solid electrolyte layer (210) may include a fine particle type solid electrolyte, and the second solid electrolyte layer (220) may include a bulk particle type solid electrolyte having a larger size than the fine particle type solid electrolyte included in the first solid electrolyte layer (210).

In addition, the second solid electrolyte layer (220) may further include the fine particle type solid electrolyte of the first solid electrolyte layer (210).

In addition, the hybrid solid electrolyte (200) may include a porous polymer film, and the at least two solid electrolyte layers may be located on opposite surfaces of the porous polymer film, respectively.

In addition, the negative electrode (100) may be configured such that carbon is provided at a part or the entirety of the surface of silicon oxide, and the carbon may be included so as to account for 0.5 mass % to less than 5 mass %.

The present invention provides an all-solid-state battery manufacturing method including (s1) a step of coating one surface of a porous polymer film with a first solid electrolyte, (s2) a step of coating the other surface of the porous polymer film having the first solid electrolyte provided thereon by coating in step (s1) with a second solid electrolyte, (s3) a step of drying and pressing the porous polymer film having the second solid electrolyte provided thereon by coating in step (s2) to form a hybrid solid electrolyte, and (s4) a step of forming a negative electrode and a positive electrode on opposite surfaces of the hybrid solid electrolyte, respectively, wherein the density of the second solid electrolyte is less than the density of the first solid electrolyte.

In step (s2), the second solid electrolyte may include a solid electrolyte having a particle size greater than the particle size of the first solid electrolyte, and in step (s4), the negative electrode may include a lithium component.

In addition, the present invention may provide various combinations of the above solving means.

According to an all-solid-state battery of the present invention, it is possible to prevent or reduce precipitation of lithium metal on an electrode, whereby it is possible to improve the performance and cycle characteristics of the all-solid-state battery.

Also, in the present invention, it is possible to improve reversibility of lithium ions during a charging and discharging process while reducing the interfacial resistance at the interface between the electrode and a solid electrolyte chamber without an additional material, whereby it is possible to reduce the production cost of the all-solid-state battery.

In addition, it is possible to prevent a short circuit phenomenon occurring as the result of increasing the thickness of a positive electrode layer in order to increase the energy capacity of the all-solid-state battery.

### BRIEF DESCRIPTION OF THE DRAWINGS

FIG. 1 is a schematic view of an all-solid-state battery including a hybrid solid electrolyte according to a first embodiment of the present invention.

FIG. 2 is a schematic view of an all-solid-state battery including a hybrid solid electrolyte according to a second embodiment of the present invention.

FIG. 3 is a view showing the results of measurement of bulk resistance of the hybrid solid electrolyte according to the present invention and a conventional solid electrolyte.

FIG. 4 is a view showing the results of measurement of charging and discharging capacities of batteries using the hybrid solid electrolyte according to the present invention and the conventional solid electrolyte.

FIG. 5 is a schematic view of an all-solid-state battery including a hybrid solid electrolyte according to a first embodiment of the present invention.

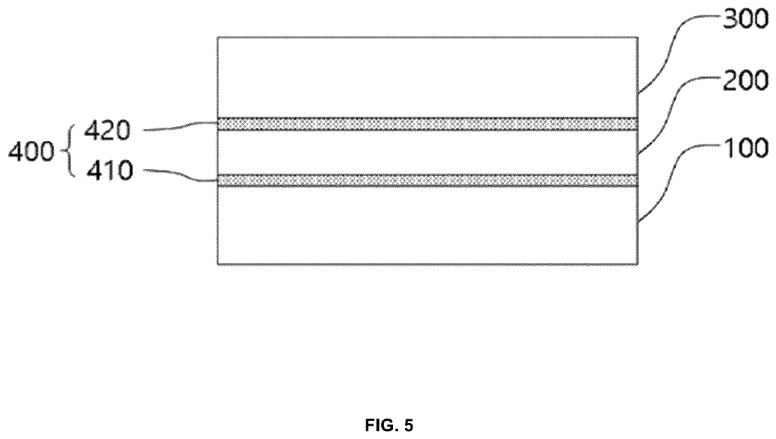

FIG. 6 is a view showing a method of measuring the dimensions of an electrode assembly according to the present invention.

FIG. 7 is a photograph showing the results of SEM analysis of a solid electrolyte according to a manufacturing method of the present invention and a solid electrolyte according to a conventional manufacturing method.

### DETAILED DESCRIPTION OF THE INVENTION

Now, preferred embodiments of the present invention will be described in detail with reference to the accompanying drawings such that the preferred embodiments of the present invention can be easily implemented by a person having ordinary skill in the art to which the present invention pertains. In describing the principle of operation of the preferred embodiments of the present invention in detail, however, a detailed description of known functions and configurations incorporated herein will be omitted when the same may obscure the subject matter of the present invention.

In addition, the same reference numbers will be used throughout the drawings to refer to parts that perform similar functions or operations. In the case in which one part is said to be connected to another part throughout the specification, not only may the one part be directly connected to the other part, but also, the one part may be indirectly connected to the other part via a further part. In addition, that a certain element is included does not mean that other elements are excluded, but means that such elements may be further included unless mentioned otherwise.

Also, in this specification, a description of a certain embodiment through limitation or addition may be applied not only to a specific embodiment but also equally to other embodiments.

Also, in the description of the invention and the claims of the present application, singular forms are intended to include plural forms unless mentioned otherwise.

Embodiments of the present invention will be described in detail with reference to the drawings.

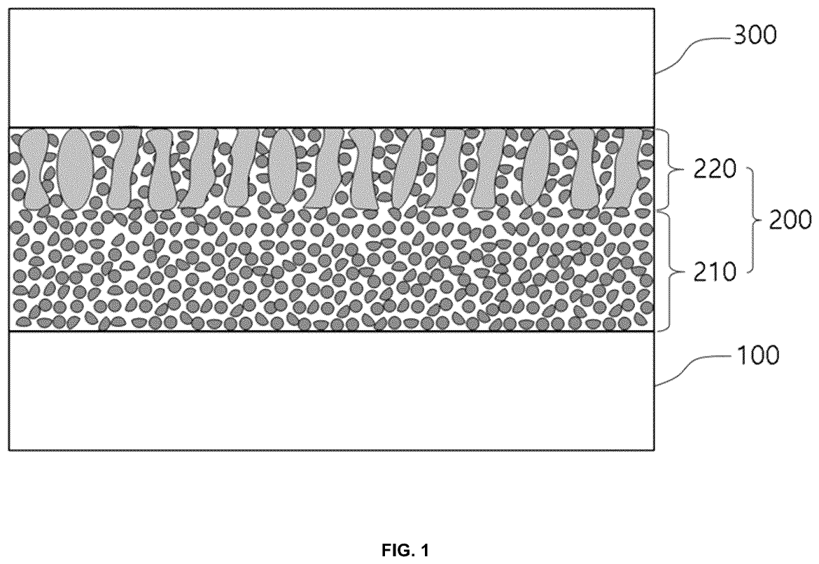

FIG. 1 is a schematic view of an all-solid-state battery including a hybrid solid electrolyte according to a first embodiment of the present invention.

Referring to FIG. 1, the all-solid-state battery according to the present invention may include a negative electrode 100, a positive electrode 300, and a hybrid solid electrolyte 200 located between the negative electrode 100 and the positive electrode 300.

A positive electrode active material may be a positive electrode active material including a Li(NiₓCo_{y}Mn_{z})O₂ (0<x<1, 0<y<1, 0<z<1, and x+y+z=1) layer and LiCoO₂ formed on a lower surface of the Li(NiₓCo_{y}Mn_{z})O₂ layer, wherein the positive electrode active material may be coated with an oxide-based solid electrolyte and a sulfide-based solid electrolyte.

In addition, the positive electrode active material may include Li₁+ₓNi₂-_{w}X_{w} (0<x<1 and 0<w<0.2) formed on an upper surface of the Li(NiₓCo_{y}Mn_{z})O₂ layer, wherein the positive electrode active material may be coated with the sulfide-based solid electrolyte after the positive electrode active material is coated with the oxide-based solid electrolyte.

In addition, the positive electrode active material may be coated with the oxide-based solid electrolyte and the sulfide-based solid electrolyte in the state in which each of the oxide-based solid electrolyte and the sulfide-based solid electrolyte has a concentration gradient.

The all-solid-state battery may include a positive electrode 100 including a positive electrode active material including a Li(NiₓCo_{y}Mn_{z})O₂ (0<x<1, 0<y<1, 0<z<1, and x+y+z=1) layer and LiCoO2 formed on a lower surface of the Li(NiₓCo_{y}Mn_{z})O₂ layer, a negative electrode 300, and a hybrid solid electrolyte 200 located between the positive electrode 100 and the negative electrode 300, wherein the hybrid solid electrolyte 200 may include at least two solid electrolyte layers having different densities.

In addition, the all-solid-state battery may include a positive electrode 100 including a positive electrode active material including Li₁+ₓNi₂-_{w}X_{w} (0<x<1 and 0<w<0.2) formed on an upper surface of the Li(NiₓCo_{y}Mn_{z})O₂ layer.

When describing the negative electrode 100 in detail first, although not shown in the figure, the negative electrode 100 may include a negative electrode current collector (not shown) and a negative electrode active material (not shown), wherein each of opposite surfaces of the negative electrode current collector may be coated with a negative electrode active material layer (not shown) or a negative electrode active material layer may be formed on only one surface of the negative electrode current collector.

The negative electrode 100 may be configured such that carbon is provided at a part or the entirety of the surface of silicon oxide, wherein the carbon may be included so as to account for 0.5 mass % to less than 5 mass %.

The negative electrode current collector may be formed so as to have a foil or plate shape. In general, the negative electrode current collector is not particularly restricted as long as the negative electrode current collector exhibits high conductivity while the negative electrode current collector does not induce any chemical change in a battery to which the negative electrode current collector is applied. For example, the negative electrode current collector may be made of copper, stainless steel, aluminum, nickel, titanium, or sintered carbon. Alternatively, the negative electrode current collector may be made of copper or stainless steel, the surface of which is treated with carbon, nickel, titanium, or silver, or an aluminum-cadmium alloy.

A carbon material capable of storing and releasing lithium ions, lithium metal, silicon, silicon, or tin may be generally used as the negative electrode active material. Specifically, the carbon material may be used as the negative electrode active material. Both low crystalline carbon and high crystalline carbon may be used as the carbon material. Typical examples of the low crystalline carbon include soft carbon and hard carbon. Typical examples of the high crystalline carbon include various kinds of high-temperature sintered carbon, such as natural graphite, Kish graphite, pyrolytic carbon, mesophase pitch based carbon fiber, meso-carbon microbeads, mesophase pitches, and petroleum or coal tar pitch derived cokes. Here, the negative electrode 100 may be configured to have a structure in which the negative electrode active material is added to the negative electrode current collector or may be configured to have a structure in which no separate negative electrode current collector is included and the negative electrode active material layer is added to one surface of the solid electrolyte.

Also, in the present invention, the negative electrode 100 may include lithium metal. Specifically, the negative electrode 100 may be configured to have a structure in which a metal layer including lithium metal or lithium is provided on one surface of the solid electrolyte by pressing or lamination.

Next, when describing the positive electrode 300, although not shown in the figure, the positive electrode may include a positive electrode current collector (not shown) and a positive electrode active material (not shown), wherein each of opposite surfaces of the positive electrode current collector may be coated with a positive electrode active material layer (not shown) or a positive electrode active material layer may be formed on only one surface of the positive electrode current collector.

In general, the positive electrode current collector is not particularly restricted as long as the positive electrode current collector exhibits high conductivity while the positive electrode current collector does not induce any chemical change in a battery to which the positive electrode current collector is applied. For example, the positive electrode current collector may be made of stainless steel, aluminum, nickel, titanium, or sintered carbon. Alternatively, the positive electrode current collector may be made of aluminum or stainless steel, the surface of which is treated with carbon, nickel, titanium, or silver. The positive electrode current collector may have a micro-scale uneven pattern formed on the surface thereof so as to increase the force of adhesion of a positive electrode active material. The positive electrode current collector may be configured in any of various forms, such as a film, a sheet, a foil, a net, a porous body, a foam body, and a non-woven fabric body.

The positive electrode active material is not particularly restricted as long as the positive electrode active material is capable of reversibly storing and releasing lithium ions. For example, the positive electrode active material may be a layered compound, such as lithium cobalt oxide (LiCoO₂), lithium nickel oxide (LiNiO₂), Li[NiₓCo_{y}Mn_{z}Mᵥ]O₂ (in the above formula, M is one or two or more selected from the group consisting of Al, Ga, and In; and 0.3≤x<1.0, 0≤y, z≤0.5, 0≤v≤0.1, and x+y+z+v=1), Li(LiₐM_{b-a-b′}M′_{b′})O₂-_{c}A_{c} (in the above formula, 0≤a≤0.2, 0.6≤b≤1, 0≤b′≤0.2 and 0≤c≤0.2; M includes at least one selected from the group consisting of Mn, Ni, Co, Fe, Cr, V, Cu, Zn, and Ti; M′ is at least one selected from the group consisting of Al, Mg, and B; and A is at least one selected from the group consisting of P, F, S, and N) or a compound substituted with one or more transition metals; a lithium manganese oxide represented by the chemical formula Li_{1+y}Mn_{2-y}O₄ (0≤y≤0.33) or a lithium manganese oxide, such as LiMnO₃, LiMn₂O₃, or LiMnO₂; a lithium copper oxide (Li₂CuO₂); a vanadium oxide, such as LiV₃O₈, LiFe₃O₄, V₂O₅, or Cu₂V₂O₇; an Ni-sited lithium nickel oxide represented by the chemical formula LiNi_{1-y}M_{y}O₂ (M=Co, Mn, Al, Cu, Fe, Mg, B, or Ga; and 0.01≤y≤0.3); a lithium manganese composite oxide represented by the chemical formula LiMn_{2-y}M_{y}O₂ (M=Co, Ni, Fe, Cr, Zn, or Ta; and 0.01≤y≤0.1) or the chemical formula Li₂Mn₃MO₈ (M=Fe, Co, Ni, Cu, or Zn); LiMn₂O₄ in which a part of Li in the chemical formula is replaced by alkaline earth metal ions; a disulfide compound; or Fe₂(MoO₄)₃. However, the present invention is not limited thereto.

Here, the positive electrode 300 may be configured to have a structure in which a positive electrode mixture layer is added to the positive electrode current collector or may be configured to have a structure in which no separate positive electrode current collector is included and a positive electrode mixture layer is added to one surface of the solid electrolyte.

In addition, each of the positive electrode 100 and the negative electrode 300 may include a conductive agent capable of improving electrical conductivity thereof. For example, graphite, such as natural graphite or artificial graphite; carbon black, such as acetylene black, Ketjen black, channel black, furnace black, lamp black, or thermal black; conductive fiber, such as carbon fiber or metallic fiber; conductive tubes, such as carbon nanotubes; metallic powder, such as carbon fluoride powder, aluminum powder, or nickel powder; conductive whisker, such as zinc oxide or potassium titanate; a conductive metal oxide, such as titanium oxide; a conductive material, such as a polyphenylene derivative, may be used as the conductive agent.

Next, when describing the hybrid solid electrolyte 200 in detail, as shown in FIG. 1, the hybrid solid electrolyte 200 according to the first embodiment of the present invention may include a first solid electrolyte layer 210 and a second solid electrolyte layer 220 located on the first solid electrolyte layer 210.

The first solid electrolyte layer 210 and the second solid electrolyte layer 220 are laminated to constitute the hybrid solid electrolyte 200, wherein the other surface of the first solid electrolyte layer 210 opposite one surface of the first solid electrolyte layer 210 that faces the second solid electrolyte layer 220 in tight contact therewith or that is integrated with the second solid electrolyte layer 220 faces the positive electrode 100 in tight contact therewith, and the other surface of the second solid electrolyte layer 220 opposite one surface of the second solid electrolyte layer 220 that faces the first solid electrolyte layer 210 in tight contact therewith or that is integrated with the first solid electrolyte layer 210 faces the negative electrode 300 in tight contact therewith.

Here, the first solid electrolyte layer 210 may include a fine powder type solid electrolyte uniformly dispersed over the entirety of the first solid electrolyte layer 210. The solid electrolyte may have a spherical or hemispherical shape, and the average particle size of the solid electrolyte may be 10 nm or less, specifically 5 to 7 nm. When the solid electrolyte is provided in a fine powder state, as described above, the specific surface area of the solid electrolyte is increased, which is advantageous in increasing the contact area between the solid electrolyte included in the first solid electrolyte layer 210 and the positive electrode 100 at the interface between the solid electrolyte and the positive electrode 100 that faces the first solid electrolyte layer and decreasing interfacial resistance at the interface between the first solid electrolyte layer 210 and the positive electrode 100.

In addition, the second solid electrolyte layer 220 includes a solid electrolyte uniformly distributed over the entirety of the second solid electrolyte layer 220. The solid electrolyte included in the second solid electrolyte layer 220 may be constituted by bulk-type, leaf-shaped coarse particles, the size of which is greater than the size of particles constituting a first solid electrolyte 211, wherein the average particle size of the solid electrolyte included in the second solid electrolyte layer 220 may be three or more times the average particle size of solid electrolyte included in the first solid electrolyte layer 210, specifically 20 nm or more. As a result, the density of the solid electrolyte in the second solid electrolyte layer 220 may be improved, whereby the interfacial resistance between the solid electrolyte particles may be reduced, and therefore it is possible to improve lithium ion conductivity. In addition, a second solid electrolyte 221 is constituted by coarse particles, not fine particles, which is advantageous in improving lithium ion conductivity in the solid electrolyte. Furthermore, conductivity of lithium ions at the interface between the second solid electrolyte layer 220 and the negative electrode 300 that faces the second solid electrolyte layer in tight contact therewith may be improved, whereby the storing speed and the releasing speed of lithium ions at the negative electrode 300 may be uniform, which is advantageous in reducing precipitation of lithium metal.

The second solid electrolyte layer 220 may include a solid electrolyte having the same shape and size as the solid electrolyte included in the first solid electrolyte layer 210. The density of the solid electrolyte included in the second solid electrolyte layer 220 may be equal to, less than, or greater than the density of the solid electrolyte included in the first solid electrolyte layer 210. The density of the solid electrolyte included in the second solid electrolyte layer 220 may be greater than the density of the solid electrolyte included in the first solid electrolyte layer 210. Specifically, the density of the solid electrolyte included in the second solid electrolyte layer 220 may be 1.5 or more times the density of the solid electrolyte included in the first solid electrolyte layer 210.

In the present invention, in order to control the density of the solid electrolyte included in each of the first solid electrolyte layer 210 and the second solid electrolyte layer 220, at least one of a spherical shape, a hemispherical shape, and a leaf shape may be selected as the particle shape of the solid electrolyte.

In the first solid electrolyte layer 210, the solid electrolyte may be formed so as to have at least one of a spherical shape and a hemispherical shape, and the solid electrolyte may be a mixture of the spherical solid electrolyte and the hemispherical solid electrolyte. The ratio by weight of the spherical solid electrolyte to the hemispherical solid electrolyte may be 0.8 to 1.2:1.0 to 1.5, specifically 1:1.2. In the first solid electrolyte layer 210, the average particle size D50 of the solid electrolyte having the above shapes may be 2 μm to 10 μm, specifically 5 μm.

In the second solid electrolyte layer 220, the solid electrolyte may be a mixture of a spherical solid electrolyte, a hemispherical solid electrolyte, and a leaf-shaped solid electrolyte. The ratio by weight of the spherical solid electrolyte to the hemispherical solid electrolyte to leaf-shaped solid electrolyte may be 0.6 to 1.0:0.8 to 1.2:0.8:1.2, specifically 0.8:1:1. In the second solid electrolyte layer 220, the average particle size D50 of the solid electrolyte having the above shapes may be 2 μm to 30 μm, specifically 15 μm.

The ratio in thickness of the first solid electrolyte layer 210 to the second solid electrolyte layer 220 may be 0.5 to 1.5:1.8 to 3, specifically 0.8 to 2.0.

The solid electrolyte included in each of the first solid electrolyte layer 210 and the second solid electrolyte layer 220 may be an oxide-based solid electrolyte, a sulfide-based solid electrolyte, or a polymer-based solid electrolyte.

As the oxide-based solid electrolyte, for example, there may be used LiₓₐLa_{ya}TiO₃ (xa=0.3 to 0.7 and ya=0.3 to 0.7) (LLT), Li_{xb}La_{yb}Zr_{zb}M^{bb}_{mb}O_{nb} (where M^{bb} is at least one of Al, Mg, Ca, Sr, V, Nb, Ta, Ti, Ge, In, and Sn, xb satisfies 5≤xb≤10, yb satisfies 1≤yb≤4, zb satisfies 1≤zb≤4, mb satisfies 0≤mb≤2, and nb satisfies 5≤nb≤20), Li_{xc}B_{yc}M^{cc}_{zc}O_{nc} (where M^{cc} is at least one of C, S, Al, Si, Ga, Ge, In, and Sn, xc satisfies 0≤xc≤5, yc satisfies 0≤yc≤1, zc satisfies 0≤zc≤1, and nc satisfies 0≤nc≤6), Li_{xd}(Al, Ga)_{yd}(Ti, Ge)_{zd}Si_{ad}P_{md}O_{nd} (1≤xd≤3, 0≤yd≤1, 0≤zd≤2, 0≤ad≤1, 0≤md≤7, and 3≤nd≤13), Li₍₃₋₂ₓₑ₎M^{ee}ₓₑD^{ee}O (where xe indicates a number between 0 and 0.1, M^{ee} indicates a bivalent metal atom, and Dee indicates a halogen atom or a combination of two or more kinds of halogen atoms), Li_{xf}Si_{yf}O_{zf} (1≤xf≤5, 0<yf≤3, and 1≤zf≤10), Li_{xg}S_{yg}O_{zg} (1≤xg≤3, 0<yg≤2, and 1≤zg≤10), Li₃BO₃-Li₂SO₄, Li₂O-B₂O₃-P₂O₅, Li₂O-SiO₂, Li₆BaLa₂Ta₂O₁₂, Li₃PO_{(4-3/2w)}N_{w} (w<1), Li_{3.5}Zn_{0.25}GeO₄ having a lithium super ionic conductor (LISICON) type crystalline structure, La_{0.55}Li_{0.35}TiO₃ having a perovskite type crystalline structure, LiTi₂P₃O₁₂ having a natrium super ionic conductor (NASICON) type crystalline structure, Li_{1+xh+yh}(Al, Ga)ₓₕ(Ti, Ge)₂₋ₓₕSi_{yh}P_{3-yh}O₁₂ (0≤xh≤1 and 0≤yh≤1), or Li₇La₃Zr₂O₁₂ (LLZ) having a garnet type crystalline structure. In addition, a phosphorus compound including Li, P, and O is preferably used. For example, lithium phosphate (Li₃PO₄), LiPON in which a part of oxygen in lithium phosphate is replaced by nitrogen, or LiPOD¹ (where D¹ is at least one selected from among Ti, V, Cr, Mn, Fe, Co, Ni, Cu, Zr, Nb, Mo, Ru, Ag, Ta, W, Pt, and Au) may be used. In addition, LiA¹ON (where A¹ is at least one selected from among Si, B, Ge, Al, C, and Ga) is preferably used.

It is preferable for the sulfide-based solid electrolyte to contain a sulfur atom (5), to exhibit ionic conductivity of metals belonging to Group 1 or 2 of the periodic table, and to exhibit high electron insulation. It is preferable for the sulfide-based solid electrolyte to contain at least L1, S, and P as elements and to exhibit high lithium ion conductivity; however, elements other than L1, S, and P may be included depending on purposes or circumstances.

Concrete examples of the sulfide-based inorganic solid electrolyte are as follows. For example, Li₂S-P₂S₅, Li₂S-P₂S₅-LiCl, Li₂S-P₂S₅-H₂S, Li₂S-P₂S₅-H₂S-LiCl, Li₂S-LiI-P₂S₅, Li₂S-LiI-Li₂O-P₂S₅, Li₂S-LiBr-P₂S₅, Li₂S-Li₂O-P₂S₅, Li₂S-Li₃PO₄-P₂S₅, Li₂S-P₂S₅-P₂O₅, Li₂S-P₂S₅-SiS₂, Li₂S-P₂S₅-SiS₂-LiCl, Li₂S-P₂S₅-SnS, Li₂S-P₂S₅-Al₂S₃, Li₂S-GeS₂, Li₂S-GeS₂-ZnS, Li₂S-Ga₂S₃, Li₂S-GeS₂-Ga₂S₃, Li₂S-GeS₂-P₂S₅, Li₂S-GeS₂-Sb₂S₅, Li₂S-GeS₂-Al₂S₃, Li₂S-SiS₂, Li₂S-Al₂S₃, Li₂S-SiS₂-Al₂S₃, Li₂S-SiS₂-P₂S₅, Li₂S-SiS₂-P₂S₅-LiI, Li₂S-SiS₂-LiI, Li₂S-SiS₂-Li₄SiO₄, Li₂S-SiS₂-Li₃PO₄, or Li₁₀GeP₂S₁₂ may be used.

The polymer-based solid electrolyte may be a solid polymer electrolyte formed by adding a polymer resin to a lithium salt that is independently solvated or a polymer gel electrolyte formed by impregnating a polymer resin with an organic electrolytic solution containing an organic solvent and a lithium salt.

The solid polymer electrolyte is not particularly restricted as long as the solid polymer electrolyte particle is made of, for example, a polymer material that is ionically conductive and is generally used as a solid electrolyte material of the all-solid-state battery. Examples of the solid polymer electrolyte may include a polyether-based polymer, a polycarbonate-based polymer, an acrylate-based polymer, a polysiloxane-based polymer, a phosphazene-based polymer, polyethylene oxide, a polyethylene derivative, an alkylene oxide derivative, a phosphoric acid ester polymer, poly agitation lysine, polyester sulfide, polyvinyl alcohol, polyvinylidene fluoride, and a polymer including an ionic dissociation group. In a concrete embodiment of the present invention, the solid polymer electrolyte may include: a branch-like copolymer formed by copolymerizing an amorphous polymer, such as polymethylmethacrylate (PMMA), polycarbonate, polysiloxane, and/or phosphazene, which is a comonomer, in the main chain of polyethylene oxide (PEO), which is a polymer resin; a comb-like polymer resin; and a crosslinking polymer resin.

The polymer gel electrolyte includes an organic electrolytic solution including a lithium salt and a polymer resin, wherein the organic electrolytic solution is included in an amount of 60 to 400 parts by weight based on weight of the polymer resin. Although the polymer resin applied to the polymer gel electrolyte is not limited to specific components, a polyvinylchloride (PVC)-based resin, a polymethylmethacrylate (PMMA)-based resin, polyacrylonitrile (PAN), polyvinylidene fluoride (PVDF), and polyvinylidene fluoride-hexafluoropropylene (PVDF-HFP) may be included.

The lithium salt is a lithium salt that can be ionized and may be represented by Li⁺X⁻. Although a negative ion of the lithium salt is not particularly restricted, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃, (CF₃)₄PF₂⁻, (CF₃)₅PF⁻, (CF₃)₆P⁻, CF₃SO₃⁻, CF₃CF₂SO₃, (CF₃SO₂)₂N⁻, (FSO₂)₂N⁻, CF₃CF₂(CF₃)₂CO⁻(CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, or (CF₃CF₂SO₂)₂N⁻ may be illustrated.

In addition, the first solid electrolyte layer 210 may include a binder. The binder may include at least one selected from the group consisting of polyethylene oxide, polyethylene glycol, polyacrylonitrile, polyvinyl chloride, polymethyl methacrylate, polypropylene oxide, polyphosphazene, polysiloxane, polydimethylsiloxane, polyvinylidene fluoride, polyvinylidene fluoride-hexafluoropropylene (PVDF-HFP), polyvinylidene fluoride-chlorotrifluoroethylene (PVDF-CTFE), polyvinylidene fluoride-tetrafluoroethylene (PVDF-TFE), polyvinylidene carbonate, and polyvinylpyrrolidone. Specifically, the binder may include at least one selected from the group consisting of polyvinylidene fluoride, polyvinylidene fluoride-hexafluoropropylene (PVDF-HFP), polyvinylidene fluoride-chlorotrifluoroethylene (PVDF-CTFE), and polyvinylidene fluoride-tetrafluoroethylene (PVDF-TFE). More specifically, the binder may include polyvinylidene fluoride-hexafluoropropylene (PVDF-HFP).

In addition, the second solid electrolyte layer 220 may include a conductive polymer and an additional compound. The conductive polymer may include at least one selected from the group consisting of polyethylene oxide, polyethyleneglycol, polypropylene oxide, polyphosphazene, polysiloxane, polyvinylidene fluoride, and a copolymer thereof. Specifically, the conductive polymer may include polyethylene oxide. The additional compound may serve to increase the permeation rate of lithium ions. The compound may include at least one selected from the group consisting of dimethyl ether (DME), tetraethylene glycol dimethyl ether (TEGDME), and polyethylene glycol dimethyl ether (PEGDME). Specifically, the compound may include polyethylene glycol dimethyl ether (PEGDME).

The second solid electrolyte layer 220 may further include a lithium salt, wherein the lithium salt may include at least one selected from the group consisting of lithium perchlorate (LiClO₄), lithium trifluoromethanesulfonate (LiCF₃SO₃), lithium hexafluorophosphate (LiPF₆), lithium tetrafluoroborate (LiBF₄), lithium bistrifluoromethanesulfonylimide (LiN(CF₃SO₂)₂), lithium bisfluorosulfonylimide (LiFSI), lithium bis(oxalato)borate (LiBOB), lithium difluoro(oxalato)borate (LiDFOB), and lithium difluoro(bisoxalato)phosphorate (LiDFBP). This is advantageous in increasing the movement speed of lithium ions.

In addition, although not shown in the figure, a porous polymer film (not shown) may be further located between the first solid electrolyte layer 210 and the second solid electrolyte layer 220.

The porous polymer film may include at least one selected from the group consisting of polyethylene terephthalate (PET), polybutylene terephthalate (PBT), polyamide (PA), polyurethane (PU), viscose rayon, low-density polyethylene (LDPE), high-density polyethylene (HDPE), medium-density polyethylene (MDPE), linear low-density polyethylene (LLDPE), polypropylene (PP), polystyrene (PS), polyvinyl chloride (PVC), and polyacrylate. In addition, the porous polymer film may be non-woven fabric.

In addition, the all-solid-state battery according to the present invention may include a battery case (not shown).

The battery case may be a case made of a metal material, may be made of a laminate sheet in which a metal layer and a resin layer are laminated, and may be provided with a reception portion, in which the positive electrode 100, the hybrid solid electrolyte 200, and the negative electrode 300 may be received. The battery case may include a heating structure in which a heat transfer layer is provided at a part of an inner surface of the battery case in order to increase the temperature of the battery case.

The heat transfer layer may be configured to generate heat when current flows in the metal material, and a power supply unit configured to supply current to the heat transfer layer may be further provided. In addition, a conventional surface heating element may be used as the heat transfer layer.

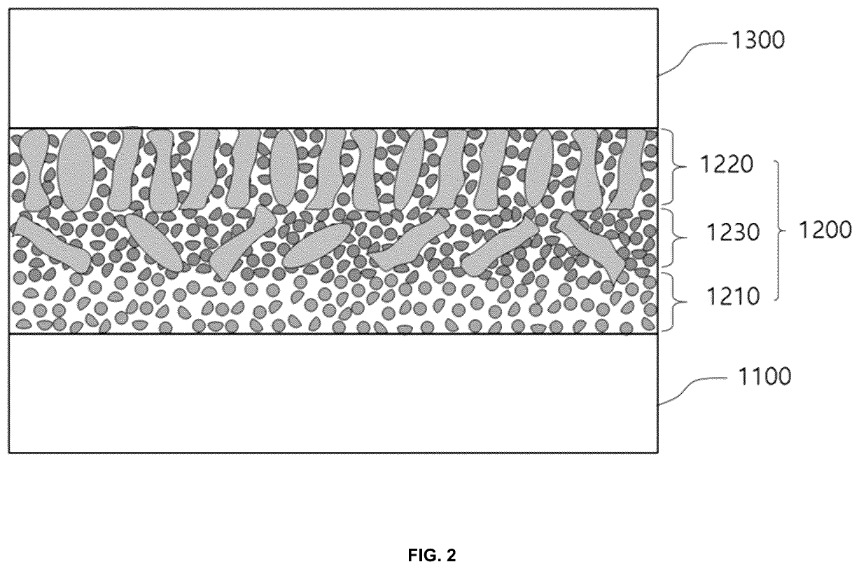

FIG. 2 is a schematic view of an all-solid-state battery including a hybrid solid electrolyte according to a second embodiment of the present invention.

The second embodiment of the present invention is identical to the first embodiment of the present invention described with reference to FIG. 1 except that the hybrid solid electrolyte 1200 further includes a third solid electrolyte layer 1230, and therefore only the third solid electrolyte layer 1230 will hereinafter be described.

Referring to FIG. 2, the hybrid solid electrolyte 1200 according to the second embodiment of the present invention may further include a third solid electrolyte layer 1230 located between a first solid electrolyte layer 1210 and a second solid electrolyte layer 1220.

The third solid electrolyte layer 1230 is identical to the first solid electrolyte layer 1210 except that the third solid electrolyte layer further includes a third solid electrolyte 1231 having a particle size greater than the particle size of a first solid electrolyte 1211.

The particle size of the solid electrolyte included in the third solid electrolyte layer 1230 may be greater than the average particle size of the solid electrolyte included in the first solid electrolyte layer 1210 and may be less than the average particle size of the second solid electrolyte 1220. When the difference between the density of the solid electrolyte included in the first solid electrolyte layer 1210 and the density of the solid electrolyte included in the second solid electrolyte layer 1220 is great, a third solid electrolyte layer 1230 including a solid electrolyte having a medium density is disposed therebetween, which is advantageous in maintaining the stable moving speed of lithium ions.

The solid electrolyte included in the third solid electrolyte layer 1230 may be formed so as to have at least one of a spherical shape, a hemispherical shape, and a leaf shape.

Meanwhile, although not shown in FIGS. 1 and 2, in the present invention, the first solid electrolyte layer, the second solid electrolyte layer, and the third solid electrolyte layer may include solid electrolytes of the same particle size in the state in which densities thereof are different depending on positions thereof. The position-specific density of the solid electrolyte is not particularly restricted as long as interfacial resistance at each interface is reduced and stable storage and release of lithium ions at the electrode are maintained.

The present invention provides an all-solid-state battery manufacturing method of coating one surface of a porous polymer film with a first solid electrolyte, coating the other surface of the porous polymer film with a second solid electrolyte having a density greater than the density of the first solid electrolyte, drying and pressing the porous polymer film having the first solid electrolyte and the second solid electrolyte provided thereon by coating, and forming a negative electrode and a positive electrode on opposite surfaces of a produced hybrid solid electrolyte, respectively. Here, the second solid electrolyte may have a particle size greater than the particle size of the first solid electrolyte, the second solid electrolyte may include the first solid electrolyte, and the negative electrode may include a lithium component.

Hereinafter, the present invention will be described with reference to the following examples; however, these examples are provided only for easier understanding of the present invention and should not be construed as limiting the scope of the present invention.

### EXAMPLE 1

A hybrid solid electrolyte layer includes a solid electrolyte in which LiLaZrO, PEO, and CAN are mixed at a ratio of 35 wt %:45 wt %:20 wt %.

The average particle size D50 of a solid electrolyte included in a first solid electrolyte layer 210 is 5 μm, and the average particle size D50 of a solid electrolyte included in a second solid electrolyte layer 220 is 15 μm.

In addition, the ratio of the thickness of the first solid electrolyte layer 210 to the thickness of the second solid electrolyte layer 220 may be 0.8:2.0.

The solid electrolyte included in a first solid electrolyte layer 210 is a mixture of a spherical solid electrolyte and a hemispherical solid electrolyte, and the ratio by weight of the spherical solid electrolyte to the hemispherical solid electrolyte is 1:1.2.

The solid electrolyte included in the second solid electrolyte layer 220 is a mixture of a spherical solid electrolyte, a hemispherical solid electrolyte, and a leaf-shaped solid electrolyte, and the ratio by weight of the spherical solid electrolyte to the hemispherical solid electrolyte to leaf-shaped solid electrolyte is 0.8:1:1.

The hybrid solid electrolyte layer was disposed on an upper end surface of a prepared positive electrode such that the first solid electrolyte layer 210 faced the upper surface of the positive electrode, a negative electrode was located on an upper surface of the second solid electrolyte layer 220, and heating and pressing were performed to manufacture an electrode assembly.

### COMPARATIVE EXAMPLE 1

A conventional solid electrolyte is disposed as follows:

A single solid electrolyte layer is disposed on an upper surface of a positive electrode active material, and a negative electrode active material is disposed on the upper surface of the positive electrode active material. A composite material generally containing carbon and having SiO2 further added thereto may be used as the negative electrode active material used herein. The solid electrolyte layer and active materials laminated as described above are heated and pressed to manufacture an electrode assembly.

### (1) Evaluation of Bulk Resistance of Solid Electrolyte Layer

The interfacial bulk resistance between the positive electrode and the solid electrolyte was measured using five samples of the electrode assembly according to Example 1 and four samples of the electrode assembly according to Comparative Example. The bulk resistance of the electrode assembly was evaluated as follows: the surface resistance of the electrode assembly at a size of 15 cm wide and 12 cm tall was measured using a probe resistance meter.

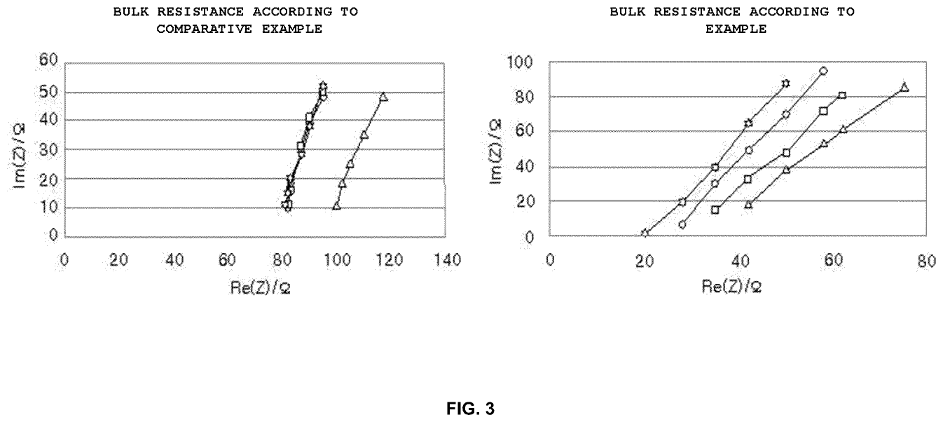

The interfacial surface resistance measurement results are shown in Table 1 below and FIG. 3.

It can be seen that the average bulk surface resistance of the hybrid solid electrolyte according to the present invention is 29.2 Ω, which is 59.4% lower than the average bulk surface resistance of the conventional solid electrolyte, which is 88.6 Ω.

TABLE 1

Bulk surface resistance of solid electrolyte (Ω)

| No. | Comparative Example 1 | Example 1 |
|---|---|---|
| 1 | 100.1 | 20 |
| 2 | 86.37 | 26 |
| 3 | 82.31 | 29 |
| 4 | 85.67 | 35 |
| 5 | | 36 |
| Average | 88.6 | 29.2 |

### (2) Evaluation of Charging and Discharging Capacities of Battery

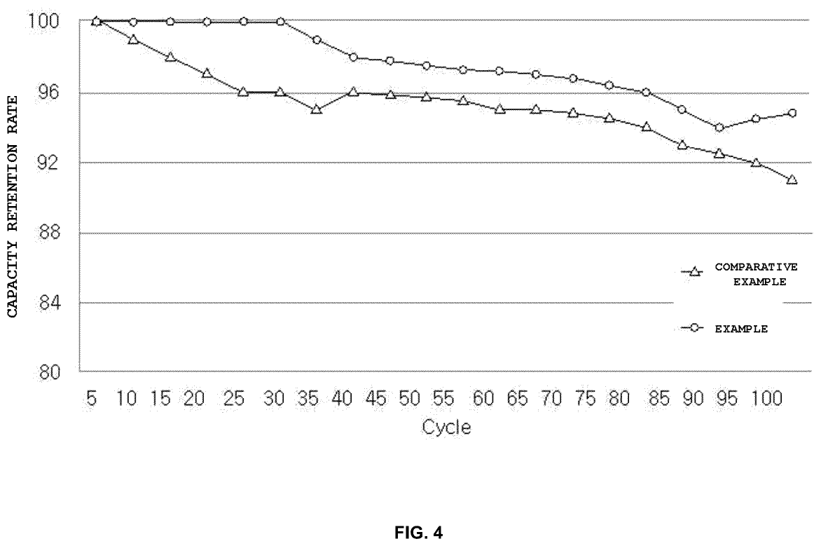

100 cycle charging and discharging repetition tests were performed using the electrode assembly according to Example 1 and the electrode assembly according to Comparative Example 1 at an operating temperature of 70° C., an open circuit voltage (OCV) of 3.07 V, a current rate of 0.5 C, and a cut off voltage of 3.0 to 4.1 V, and the results thereof are shown in FIG. 4.

FIG. 4 shows the results of measurement of charging and discharging capacities of batteries using the hybrid solid electrolyte according to the present invention and the conventional solid electrolyte.

It can be seen that the capacity retention rate of the electrode assembly according to Example 1 of the present invention is 94.8%, which is about 4% better than the capacity retention rate of the conventional electrode assembly, which is 91.2%.

In the present invention, as described above, a hybrid solid electrolyte including solid electrolyte layers having different densities is provided, whereby it is possible to reduce the interfacial resistance at the interface therebetween and at the same time to prevent precipitation of lithium metal on the electrode.

An all-solid-state battery may include a composite positive electrode 100, a negative electrode 300, and a solid electrolyte 200 located between the composite positive electrode 100 and the negative electrode 300, wherein a first composite film 410 may be located between the composite positive electrode 100 and the solid electrolyte 200, a second composite film 420 may be located between the negative electrode 300 and the solid electrolyte 200, and each of the first composite film 410 and the second composite film 420 may include a lithium salt, a composite binder, and a conductive agent.

The first composite film 410 and the second composite film 420 may be separately manufactured and may be disposed between the composite positive electrode 100 and the solid electrolyte 200 and between the negative electrode 300 and the solid electrolyte 200, respectively.

The composite binder may include an inorganic binder and an organic binder.

The organic binder may be included so as to account for 25 wt % to 35 wt %, and the organic binder may be butadiene.

The inorganic binder may include solid-phase silica, and the conductive agent may be a carbon-based conductive agent.

The first composite film 410 may include a positive electrode active material of the positive electrode 100.

In addition, each of the first composite film 410 and the second composite film 420 may include the solid electrolyte.

The solid electrolyte 200 may be an oxide-based solid electrolyte.

The present invention may provide an all-solid-state battery manufacturing method including (s1) a step of manufacturing a positive electrode, (s2) a step of manufacturing a composite film layer including a lithium salt, a lithium ion conductive polymer, a conductive agent, and a composite binder, (s3) a step of manufacturing an oxide-based solid electrolyte, and (s4) a step of sequentially laminating the positive electrode, the composite film layer, the solid electrolyte, and a negative electrode to form a laminate.

In step (s4), a step of performing pressing at a temperature of 50° C. and a pressure of 40 MPa for 2 minutes may be further included.

In step (s2), the composite film layer may include a first composite film layer and a second composite film layer, and the first composite film layer may further include a positive electrode active material of the positive electrode.

In step (s4), the positive electrode may be disposed so as to face the first composite film layer.

In step (s2), the composite binder may include an inorganic binder and an organic binder, wherein the inorganic binder may include solid-phase nanosilica, and the organic binder may include butadiene.

### Manufacturing Example 1: Manufacture of Positive Electrode

70 wt % of an NCM-based positive electrode active material, 10 wt % of carbon, and 20 wt % of a solid electrolyte were mixed to manufacture a positive electrode. Here, the solid electrolyte is constituted by an oxide-based solid electrolyte and an organic binder, excluding an organic solvent, in a solid electrolyte manufacturing method, a description of which will follow.

### Manufacturing Example 2: Manufacture of Composite Film Layer

A composite film layer including a lithium salt, a lithium ion conductive polymer, a conductive agent, and a composite binder was manufactured. 15 wt % of the lithium salt, 25 wt % of polyethylene, 10 wt % of carbon, 20 wt % of SiO₂, and 30 wt % of butadiene were mixed to manufacture a composite film layer.

### Manufacturing Example 3: Manufacture of Solid Electrolyte according to the present invention

35 wt % of LiLaZrO, 45 wt % of PEO, and 20 wt % of CAN (acetonitrile) were mixed to manufacture a solid electrolyte.

In the present invention, LiLaZrO, an organic binder (PEO, PVDF, or PO), and an organic solvent (CAN, acetonitrile) may be mixed at a ratio of 30 to 40 wt % (35 wt %):40 to 50 wt % (45 wt %):15 to 30 wt % (20 wt %). Specifically, 35 wt % of LiLaZrO, 45 wt % of PEO, and 20 wt % of CAN (acetonitrile) may be mixed and dried to manufacture a solid electrolyte.

### Manufacturing Example 4: Manufacture of Conventional Solid electrolyte

LiLaZrO, an organic binder (PEO, PVDF, or PO), and an organic solvent (CAN, acetonitrile) may be mixed at a ratio of 30 to 40 wt % (35 wt %):40 to 50 wt % (45 wt %):15 to 30 wt % (20 wt %) to manufacture a slurry, a PET film may be coated with the slurry using casting equipment (molding machine), and drying may be performed to manufacture a conventional solid electrolyte.

### EXAMPLE 2

A first composite film layer manufactured according to Manufacturing Example 2 is disposed on an upper surface of the positive electrode manufactured according to Manufacturing Example 1, the solid electrolyte manufactured according to Manufacturing Example 3 is disposed on an upper surface of the composite film layer, a second composite film layer manufactured according to Manufacturing Example 2 is disposed on an upper surface of the solid electrolyte, and a negative electrode constituted by a lithium plate is disposed on an upper surface of the second composite film layer to form a laminate.

The laminate was pressed at a temperature of 50° C. and a pressure of 40 MPa for 2 minutes to manufacture an electrode assembly.

### COMPARATIVE EXAMPLE 2

An electrode assembly was manufactured using the same method as in Example 2 except that the first composite film layer and the second composite film layer were not included

### TEST EXAMPLE

### (1) Evaluation of Interfacial Bonding Force

The interfacial bonding force between the positive electrode and the solid electrolyte was measured using 10 samples of the electrode assembly according to each of Example 2 and Comparative Example 2. A method of measuring the interfacial bonding force between the positive electrode and the solid electrolyte of the electrode assembly was performed as follows: a composite film layer was laminated on an Li metal substrate to form a flexible band, the band was pulled upwards in the state in which an angle of 90° was maintained, and the strength at which separation occurred at the interface therebetween was measured as interfacial bonding force.

The interfacial bonding force measurement results are shown in Table 2 below. It can be seen that the average interfacial bonding force between the positive electrode and the solid electrolyte according to the present invention is 1.17 kgf/cm², which is a 25% improvement over the average interfacial bonding force between the conventional positive electrode and the conventional solid electrolyte, which is 0.93 kgf/cm².

TABLE 2

Interfacial bonding force (kgf/cm²)

| No. | Comparative Example 2 | Example 2 |
|---|---|---|
| 1 | 1 | 1.2 |
| 2 | 0.9 | 1.2 |
| 3 | 1 | 1.1 |
| 4 | 0.8 | 1.2 |
| 5 | 0.9 | 1.1 |
| 6 | 1 | 1.3 |
| 7 | 1.1 | 1.1 |
| 8 | 0.7 | 1.2 |
| 9 | 0.9 | 1.1 |
| 10 | 1 | 1.2 |
| Average | 0.93 | 1.17 |

### (2) Evaluation of Bulk Resistance of Composite Film Layer

The bulk interfacial resistance between the positive electrode and the solid electrolyte was measured using 10 samples of the electrode assembly according to each of Example 2 and Comparative Example 2. The bulk resistance of the composite film layer of the electrode assembly was evaluated as follows: the surface resistance of each of the solid electrolyte binder film layer and the conventional solid electrolyte sintered layer at a size of 15 cm wide and 12 cm tall was measured using a probe resistance meter.

The interfacial surface resistance measurement results are shown in Table 3 below. It can be seen that the surface resistance of the binder film layer of the solid electrolyte according to the present invention is 41.4 Ω, which is 43% lower than the bulk surface resistance of the conventional solid electrolyte sintered layer and the conventional solid electrolyte binder film layer, which is 74.2 Ω.

TABLE 3

Bulk surface resistance of solid electrolyte (Ω)

| No. | Comparative Example 2 | Example 2 |
|---|---|---|
| 1 | 75 | 42 |
| 2 | 73 | 41 |
| 3 | 72 | 40 |
| 4 | 75 | 42 |
| 5 | 76 | 39 |
| 6 | 74 | 42 |
| 7 | 72 | 40 |
| 8 | 75 | 43 |
| 9 | 76 | 42 |
| 10 | 74 | 43 |
| Average | 74.2 | 41.4 |

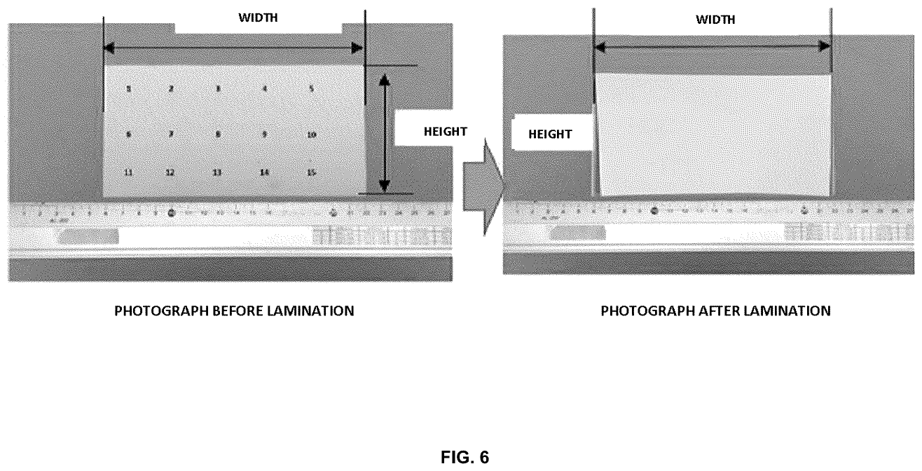

(3) Evaluation of lamination strain: FIG. 6 shows a photograph before lamination and a method of measuring the width and the height of an electrode assembly after lamination.

Dimensional strain after lamination was measured using 10 samples of the electrode assembly according to each of Example 1 and Comparative Example 2, i.e. 10 samples of the electrode assembly obtained by heating and pressing the positive electrode, the composite film layer, the solid electrolyte, the composite film layer, and the negative electrode. In the present invention, the dimensions of the electrode assembly deformed in both width and height by heating and pressing, as shown in FIG. 2, were measured, and the strain was calculated using the following formula.

Dimensional strain after lamination=(area before lamination−area after lamination)/area before lamination*100% (1)

Area before lamination=width before lamination*height before lamination (2)

Area after lamination=width after lamination*height after lamination (3)

The results of calculation of the dimensional strain after lamination are shown in Table 4 below. It can be seen that the dimensional strain of the electrode assembly after lamination according to the conventional method is 14.46%, which is 3 or more times the dimensional strain of the electrode assembly after lamination according to the method of the present invention, which is 4.61%, and that the electrode assembly according to the present invention has reduced dimensional strain after lamination compared to the conventional method.

TABLE 4

Dimensional strain after lamination (Ω)

| No. | Comparative Example 2 | Example 2 |
|---|---|---|
| 1 | 13.3 | 5.1 |
| 2 | 14.2 | 4.1 |
| 3 | 13.3 | 4.3 |
| 4 | 15.1 | 4.2 |
| 5 | 13.5 | 4.9 |
| 6 | 12.9 | 4.6 |
| 7 | 14.3 | 4.8 |
| 8 | 15.9 | 5 |
| 9 | 16.4 | 4.8 |
| 10 | 15.7 | 4.3 |
| Average | 14.46 | 4.61 |

(4) Evaluation of surface wetting tension: The area to be bonded between the solid electrolyte layer and the positive electrode layer may be increased due to the surface wetting tension, fluidity and bonding force between the binder, the electrolyte, and the positive electrode material may be excellent, and interfacial bonding force may be excellent without delamination or void at the interface when temperature and pressure are applied. In general, higher surface wetting tension indicates better interfacial bonding force and lamination efficiency.

The surface wetting tension was measured using 10 samples of the electrode assembly according to each of Example 2 and Comparative Example 2. In a method of evaluating the surface wetting tension, the surface wetting tension was evaluated according to the international evaluation standard JIS K6788.

It can be seen from Table 5 that the surface wetting tension according to the present invention is 53.8 dynes/cm, which is 8.9% better than the conventional surface wetting tension, which is 49.4 dynes/cm.

TABLE 5

Surface wetting tension (dynes/cm)

| No. | Comparative Example 2 | Example 2 |
|---|---|---|
| 1 | 48 | 53 |
| 2 | 49 | 54 |
| 3 | 50 | 55 |
| 4 | 51 | 52 |
| 5 | 51 | 54 |
| 6 | 48 | 54 |
| 7 | 50 | 53 |
| 8 | 50 | 54 |
| 9 | 48 | 55 |
| 10 | 49 | 54 |
| Average | 49.4 | 53.8 |

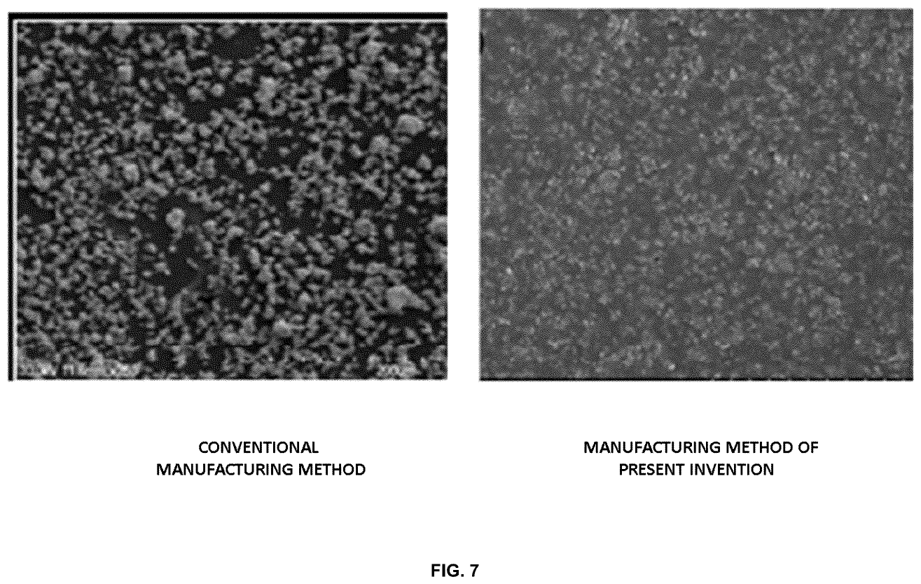

Surface dispersibility: In order to compare powder dispersibility of the solid electrolyte according to the manufacturing method of the present invention described in Manufacturing Example 3 to powder dispersibility of the solid electrolyte according to the conventional manufacturing method described in Manufacturing Example 4, the results of SEM analysis of surfaces of the solid electrolytes manufactured using the two methods are shown in FIG. 7.

It was analyzed that the average particle size of the solid electrolyte according to the manufacturing method of the present invention was in a range of 1 to 5 um and that the average particle size of the solid electrolyte according to the conventional manufacturing method was in a range of 20 to 30 um.

It can be seen therefrom that the powder particles according to the manufacturing method of the present invention are small, whereby the specific surface area is high, and the density is excellent due to the high cohesion between the powder particles at a small thickness per unit area, whereby the density of the laminated solid electrolyte layer at a small thickness thereof is increased, which results in high energy density per volume and improved lamination efficiency.

### (6) Water Resistance

When the electrode assembly constituted by the positive electrode, the solid electrolyte, and the negative electrode according to Comparative Example 2 was introduced into water at a depth of 30 cm, the water penetration time at the interface was 5 to 8 sec, and when the electrode assembly constituted by the positive electrode, the composite film layer, the solid electrolyte, the composite film layer, and the negative electrode heated and pressed according to Example 1 of the present invention was introduced into water at a depth of 30 cm, the water penetration time at the interface was 10 to 12 sec, from which it can be seen that the water penetration time is delayed by about 2 to 7 sec. It can also be seen therefrom that the electrode assembly according to the manufacturing method of the present invention has improved water resistance.

In the present invention, as described above, a hybrid solid electrolyte including solid electrolyte layers having different densities is provided, whereby it is possible to reduce the interfacial resistance at the interface therebetween and at the same time to prevent precipitation of lithium metal on an electrode.

Those skilled in the art to which the present invention pertains will appreciate that various applications and modifications are possible within the category of the present invention based on the above description.

### DESCRIPTION OF REFERENCE NUMERALS

100, 1100: Positive electrodes
200, 1200: Hybrid solid electrolytes
210, 1210: First solid electrolyte layers
220, 1220: Second solid electrolyte layers
1230: Third solid electrolyte layer
300, 1300: Negative electrodes
400: Composite film layer
410: First composite film layer
420: Second composite film layer

What is claimed is:

1. A positive electrode active material comprising:
a Li(NiₓCo_{y}Mn_{z})O₂ (0<x<1, 0<y<1, 0<z<1, and x+y+z=1) layer; and
LiCoO₂ formed on a lower surface of the Li(NiₓCo_{y}Mn_{z})O₂ layer, wherein
the positive electrode active material is coated with an oxide-based solid electrolyte and a sulfide-based solid electrolyte.

2. The positive electrode active material according to claim 1, comprising:
Li₁₊ₓNi_{2-w}X_{w} (0<x<1 and 0<w<0.2) formed on an upper surface of the Li(NiₓCo_{y}Mn_{z})O₂ layer, wherein
the positive electrode active material is coated with the sulfide-based solid electrolyte after the positive electrode active material is coated with the oxide-based solid electrolyte.

3. The positive electrode active material according to claim 1, wherein the positive electrode active material is coated with the oxide-based solid electrolyte and the sulfide-based solid electrolyte in a state in which each of the oxide-based solid electrolyte and the sulfide-based solid electrolyte has a concentration gradient.

4. An all-solid-state battery comprising:
a positive electrode (100) comprising a positive electrode active material coated with an oxide-based solid electrolyte and a sulfide-based solid electrolyte;
a negative electrode (300); and
a hybrid solid electrolyte (200) located between the positive electrode (100) and the negative electrode (300), wherein
the hybrid solid electrolyte (200) comprises at least two solid electrolyte layers having different densities.

5. The all-solid-state battery according to claim 4, wherein the hybrid solid electrolyte (200) comprises:
a first solid electrolyte layer (210) comprising a low-density solid electrolyte; and
a second solid electrolyte layer (220) comprising a high-density solid electrolyte.

6. The all-solid-state battery according to claim 5, wherein the second solid electrolyte layer (220) further comprises a lithium salt.

7. The all-solid-state battery according to claim 5, wherein
the first solid electrolyte layer (210) is located so as to face the positive electrode (100), and
the second solid electrolyte layer (220) is located so as to face the negative electrode (300).

8. The all-solid-state battery according to claim 5, wherein
the first solid electrolyte layer (210) comprises a fine particle type solid electrolyte, and
the second solid electrolyte layer (220) comprises a bulk particle type solid electrolyte having a larger size than the fine particle type solid electrolyte included in the first solid electrolyte layer (210).

9. The all-solid-state battery according to claim 8, wherein the second solid electrolyte layer (220) further comprises the fine particle type solid electrolyte of the first solid electrolyte layer (210).

10. The all-solid-state battery according to claim 4, wherein
the hybrid solid electrolyte (200) comprises a porous polymer film, and
the at least two solid electrolyte layers are located on opposite surfaces of the porous polymer film, respectively.

11. The all-solid-state battery according to claim 4, wherein
the negative electrode (100) is configured such that carbon is provided at a part or the entirety of a surface of silicon oxide, and
the carbon is included so as to account for 0.5 mass % to less than 5 mass %.

12. The all-solid-state battery according to claim 5, wherein
a buffer solid electrolyte layer is located between the first solid electrolyte layer (210) and the second solid electrolyte layer (220), and
the buffer solid electrolyte layer comprises a solid electrolyte having higher density than the low-density solid electrolyte and lower density than the high-density solid electrolyte.
